(19) United States
(12) Patent Application Publication
(10) Pub. No.: US 2025/0050765 A1
(43) Pub. Date: Feb. 13, 2025

(54) VEHICLE AND CHARGING CONTROL METHOD OF VEHICLE

(71) Applicants: HYUNDAI MOTOR COMPANY, Seoul (KR); KIA CORPORATION, Seoul (KR)

(72) Inventors: Sung Min Hong, Hwaseong-si (KR); Yong Gyu Lee, Hwaseong-si (KR)

(73) Assignees: HYUNDAI MOTOR COMPANY, Seoul (KR); KIA CORPORATION, Seoul (KR)

(21) Appl. No.: 18/798,390

(22) Filed: Aug. 8, 2024

(30) Foreign Application Priority Data
Aug. 11, 2023 (KR) 10-2023-0105806
Jul. 30, 2024 (KR) 10-2024-0100940

(51) Int. Cl. B60L 53/24; B60L 53/10; B60L 53/62; H01M 10/44; H01M 10/46; H02P 27/08

(52) U.S. Cl. CPC B60L 53/24; B60L 53/11; B60L 53/62; H01M 10/441; H01M 10/46; H02P 27/08; B60L 2210/42; H01M 2220/20

(57) ABSTRACT

A vehicle includes a plurality of single-phase battery module systems including a plurality of battery modules, and provided in each phase of a motor, wherein each of the plurality of battery modules includes a battery and a power conversion module, and the power conversion module includes an inverter configured to convert a DC voltage stored in the battery into an AC voltage and to control the motor; and a control module, wherein the control module includes one or more processors; and a storage medium configured to store computer-readable instructions, and wherein, when a computer-readable instruction is executed by one or more processors, the one or more processors is configured such that a charging current provided from the charger is controlled by each of the plurality of single-phase battery module systems.

### CROSS REFERENCE TO RELATED APPLICATIONS

This application claims benefit of priority to Korean Patent Application No. 10-2024-0100940 filed on Jul. 30, 2024 and Korean Patent Application No. 10-2023-0105806 filed on Aug. 11, 2023 in the Korean Intellectual Property Office, the disclosures of which are incorporated herein by reference in their entirety.

### BACKGROUND

### 1. Field

The present disclosure relates to a vehicle and a charging control method of vehicle.

### 2. Description of Related Art

It is noted that this section merely provides background information on the present disclosure and does not constitute the prior art.

An eco-friendly vehicle may refer to a hybrid electric vehicle, an electric vehicle, a fuel cell electric vehicle, or the like, and may include a high-voltage battery pack, an inverter, a motor, and the like.

A drive system of such an eco-friendly vehicle may include a battery pack and an inverter as separate devices, and during rapid charging, a rapid charging device may charge a high-voltage battery pack, and during slow charging, the charger mounted on the vehicle may be configured to charge the high-voltage battery pack.

### SUMMARY

An aspect of the present disclosure is to provide a vehicle and a charging control method of a vehicle which may improve a charging speed, may prevent a temperature rise of a battery module and may be charged using a general charger.

According to an aspect of the present disclosure, a vehicle includes a plurality of single-phase battery module systems including a plurality of battery modules, and provided in each phase of a motor, wherein each of the plurality of battery modules includes a battery and a power conversion module, and the power conversion module includes an inverter configured to convert a DC voltage stored in the battery into an AC voltage and to control the motor, and a control module, wherein the control module includes one or more processors, and a storage medium configured to store computer-readable instructions, and wherein, when a computer-readable instruction is executed by one or more processors, the one or more processors is configured such that a charging current provided from the charger is controlled by each of the plurality of single-phase battery module systems.

The one or more processors may control the charging current for each of the plurality of single-phase battery module systems by performing pulse width modulation (PWM) control on an inverter included in the single-phase battery module system for each of the plurality of single-phase battery module systems.

The one or more processors may control the charging current equally for the entirety of the plurality of single-phase battery module systems by performing pulse width modulation (PWM) control for the entirety of inverters included in the single-phase battery module system of the plurality of single-phase battery module systems according to the same duty ratio.

The one or more processors may control the charging current differently for the plurality of single-phase battery module systems by performing pulse width modulation (PWM) control for an inverter included in a single-phase battery module system according to different duty ratios for the plurality of single-phase battery module systems.

The one or more processors may perform sequential pulse width modulation control for an inverter included in a single-phase battery module system for each of the plurality of single-phase battery module systems.

When at least one of batteries included in the plurality of battery modules has a predetermined temperature or higher, the one or more processors may reduce a duty ratio of an inverter provided in a single-phase battery module system including the battery having a predetermined temperature or higher.

The charger may provide a DC charging current.

Input ends of the battery and the inverter may be connected to each other in parallel, and an output end of the inverter may be connected in series to an output end of an inverter included in an adjacent battery module.

The vehicle may further include a plurality of switches configured to open and close connection between each of the plurality of single-phase battery module systems and a charger.

One ends of the plurality of switches may be interconnected and connected to a (+) terminal of the charger, and the other ends of the plurality of switches are connected to the plurality of single-phase battery module systems, respectively.

The other end of each of the plurality of switches may be connected to one end among output ends of an inverter included in one of the plurality of battery modules included in each of the plurality of single-phase battery module systems.

The other end among output ends of the inverter included in a battery module among the plurality of battery modules included in a single-phase battery module system among the plurality of single-phase battery module systems may be interconnected with the other end among output ends of the inverter included in a battery module among the plurality of battery modules included in another single-phase battery module system among the plurality of single-phase battery module systems and may be connected to a (−) terminal of the charger.

The vehicle may further include a motor including a plurality of motor windings.

One ends of the plurality of motor windings are interconnected and connected to the (+) terminal of the charger, and the other ends of the plurality of stator windings are connected to the plurality of single-phase battery module systems, respectively.

The other end of each of the plurality of stator windings may be connected to one end among output ends of an inverter included in one of the plurality of battery modules included in each of the plurality of single-phase battery module systems.

The other end among output ends of the inverter included in one of the plurality of battery modules included in a single-phase battery module system among the plurality of single-phase battery module systems may be interconnected with the other end among output ends of the inverter included in one of the plurality of battery modules included in another single-phase battery module system among the plurality of single-phase battery module systems and may be connected to the (−) terminal of the charger.

The inverter may include an upper switch and a lower switch provided in a first leg and connected to each other in series; and an upper switch and a lower switch provided in a second leg and connected to each other in series, wherein one end among output ends of the inverter may be between an upper switch and a lower switch of the first leg, and wherein the other end among output ends of the inverter may be between an upper switch and a lower switch of the second leg.

The number of the plurality of battery modules included in one single-phase battery module system among the plurality of single-phase battery module systems may be the same as the number of the plurality of battery modules included in the other single-phase battery module system among the plurality of single-phase battery module systems.

The inverter may include an H-bridge single-phase inverter including a plurality of power semiconductor devices.

During DC charging, the upper switch of the first leg and the lower switch of the second leg may be turned on, or the lower switch of the first leg and the upper switch of the second leg may be turned on.

According to an aspect of the present disclosure, a charging method of a vehicle including a plurality of single-phase battery module systems including a plurality of battery modules, and provided in each phase of a motor, wherein each of the plurality of battery modules includes a battery and a power conversion module, and the power conversion module includes an inverter configured to convert a DC voltage stored in the battery into an AC voltage and to control the motor includes a receiving operation of receiving a charging signal from a charger; and a control operation of controlling a charging current provided from the charger for each of the plurality of single-phase battery module systems when the charging signal is received.

The control operation may include controlling the charging current for each of the plurality of single-phase battery module systems by performing pulse width modulation (PWM) control on an inverter included in the single-phase battery module system for each of the plurality of single-phase battery module systems.

The control operation may include controlling the charging current equally for the entirety of the plurality of single-phase battery module systems by performing pulse width modulation (PWM) control for the entirety of inverters included in a single-phase battery module system of the plurality of single-phase battery module systems according to the same duty ratio.

The control operation may include controlling the charging current differently for each of the plurality of single-phase battery module systems by performing pulse width modulation (PWM) control for an inverter included in a single-phase battery module system according to different duty ratios for the plurality of single-phase battery module systems.

The control operation may include performing pulse width modulation control in sequence for an inverter included in a single-phase battery module system for each of the plurality of single-phase battery module systems.

The control operation may include reducing, when at least one of batteries included in the plurality of battery modules has a predetermined temperature or higher, a duty ratio of an inverter provided in a single-phase battery module system including a battery having a predetermined temperature or higher.

### BRIEF DESCRIPTION OF THE FIGURES

The above and other aspects, features, and advantages of the present disclosure will be more clearly understood from the following detailed description, taken in conjunction with the accompanying drawings, in which:

FIG. 1 illustrates an electric vehicle driving system including a general high-voltage battery pack;

FIGS. 2 and 3 illustrate a battery module according to an example embodiment of the present disclosure;

FIG. 4 is a diagram illustrating a connection structure between a plurality of battery modules according to an example embodiment of the present disclosure;

FIG. 5 illustrates a single-phase battery module system according to an example embodiment of the present disclosure;

FIG. 6 is a diagram illustrating a connection relationship between inverters in a three-phase battery module system according to an example embodiment of the present disclosure;

FIG. 7 is a diagram illustrating a connection relationship between first DC/DC converters in a three-phase battery module system according to an example embodiment of the present disclosure;

FIG. 8 is a diagram illustrating a connection relationship between second DC/DC converters in a three-phase battery module system according to an example embodiment of the present disclosure;

FIG. 9 is a diagram illustrating an inverter structure according to an example embodiment of the present disclosure;

FIG. 10 is a configuration diagram illustrating a vehicle according to an example embodiment of the present disclosure;

FIG. 11 is a diagram illustrating a charging path of a vehicle according to an example embodiment of the present disclosure;

FIG. 12 is a diagram illustrating a charging current applied consecutively to each phase of a motor according to an example embodiment of the present disclosure;

FIG. 13 is a diagram illustrating a charging current controlled equally for each phase of a motor through a pulse-width modulation method according to an example embodiment of the present disclosure;

FIG. 14 is a diagram illustrating a charging current controlled differently for each phase of a motor through a pulse-width modulation method according to an example embodiment of the present disclosure;

FIG. 15 is a configuration diagram illustrating a vehicle according to an example embodiment of the present disclosure;

FIG. 16 is a flowchart illustrating a charging control method of a vehicle according to an example embodiment of the present disclosure; and

FIG. 17 is a block diagram illustrating a computing device which may fully or partially implement a control module according to an example embodiment of the present disclosure.

### DETAILED DESCRIPTION

Hereinafter, specific example embodiments of the present disclosure will be described with reference to the accompanying drawings. The following detailed description is provided to aid in a comprehensive understanding of a method, a device and/or a system described in the present specification. However, the detailed description is for illustrative purposes only, and the present disclosure is not limited thereto.

In describing the example embodiments of the present disclosure, when it is determined that a detailed description of a known technology related to the present disclosure may unnecessarily obscure the gist of the present disclosure, the detailed description thereof will be omitted. In addition, terms to be described below are terms defined in consideration of functions in the present disclosure, which may vary depending on intention or custom of a user or operator. Accordingly, the definition of these terms should be made based on the contents throughout the present specification. The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

In addition, a “module voltage” to be described below may refer to a voltage output from a battery module, and a “system voltage” may refer to a voltage output from a battery module system formed based on the battery module.

The battery module to be described below may include a vehicle battery module, and the battery module system may include a single-phase vehicle battery module system and a three-phase vehicle battery module system.

In addition, the present disclosure may be used not only for vehicles but also for various devices to which a battery module and a battery module system are applicable.

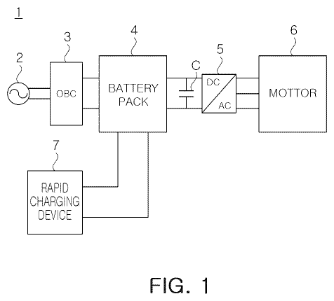

FIG. 1 illustrates a driving system of an eco-friendly vehicle including a general high-voltage battery pack.

As illustrated in FIG. 1, the driving system 1 of an eco-friendly vehicle may include an on-board charger (OBC) 3, a high-voltage battery pack 4, an inverter 5 including a DC link capacitor C and a motor 6.

According to this configuration, the charger 7 may be connected to the high-voltage battery pack 4 and may rapidly charge the high-voltage battery pack 4 using DC power, and the on-board charger 3 may convert AC power provided by the AC power source 2 into DC power and may slowly charge the high-voltage battery pack 4 using the DC power. The above-described high-voltage battery pack 4 may include a plurality of battery modules. The inverter 5 may convert DC voltage stored in the high-voltage battery pack 4 into AC voltage and may drive the motor 5.

That is, the driving system 1 of a general eco-friendly vehicle may include a battery pack 3 and an inverter 4 as separate devices. In addition, since the entire high-voltage battery pack 4 is charged at the same time during charging, it may not be possible to charge only a portion of battery modules, and overall battery heat generation may increase during charging.

In addition, since the driving system 1 of the eco-friendly vehicle operates at high voltage (e.g., 400 V to 800 V), high-voltage components may need to be used, but high-voltage components may be expensive compared to components operating at low voltage, and may generate extensive heat. Particularly, a SiC power semiconductor for high-voltage switching may be applied to the inverter 4 operating at high voltage, but the SiC power semiconductor may have a low yield for high demand, such that the semiconductor may not be easily supplied and may be expensive.

Since the high-voltage battery pack 3 has only one type of high-voltage output, various power conversion devices may be necessary to be applied to an eco-friendly vehicle. This is because an eco-friendly vehicle may have electrical loads having various functions, and the voltage required for each electrical load may be different.

For example, an eco-friendly vehicle may have various types of electrical loads requiring various voltages, such as a low-voltage load such as a radio operating at low-voltage direct current voltage (e.g., 12 V or 24 V), a high-voltage load such as an air conditioning system operating at high-voltage direct current voltage (e.g., 400 V or 800 V), and a motor operating at high-voltage three-phase AC voltage (e.g., 400 V or 800 V). Accordingly, various types of voltages may be required depending on the type of components.

Such various power conversion devices may cause energy loss in the process of converting power from high voltage to low voltage, which may lower efficiency, and as the voltage needs to be significantly lowered, a separate transformer may be necessary.

In addition, the general driving system 1 of the eco-friendly vehicle may need to have a capacitor for each of the various power conversion devices and a high-capacity capacitor, such that the system may be expensive and may take up a great deal of volume.

In addition, the general driving system 1 of the eco-friendly vehicle may have the disadvantage in that, when a problem occurs in one of the battery cells included in the high-voltage battery pack 3, the entire high-voltage battery pack 3 may need to be replaced, and when a failure occurs in one component, the entire system may be stopped, which may deteriorate reliability of the entire system.

As for the general driving system 1 of the eco-friendly vehicle, it may be necessary to design each power electric (PE) system according to different standards depending on the vehicle type, which may complicate the processes and may increase production costs.

The battery module system according to an example embodiment of the present disclosure described below may be configured by a series/parallel combination of the plurality of battery modules, and each battery module may include a low-voltage battery and a power conversion device such as an inverter and a converter operating at a low voltage.

In other words, a battery module system according to an example embodiment of the present disclosure may be configured based on a battery module, and each battery module includes a power conversion device, such that the battery module system may store/release electric energy and may also perform power conversion in the battery module. Accordingly, the battery module according to an example embodiment of the present disclosure may convert DC power supply into AC power or may convert the size of battery power and may output the power when desired. In addition, the output of each battery module may be connected to each other in series and may form a high-voltage output or may be connected to each other in parallel and may form a high-current output, and the voltage of each battery module may be monitored and may control balance. Hereinafter, the battery module according to an example embodiment of the present disclosure and the battery module system including the same will be described in greater detail.

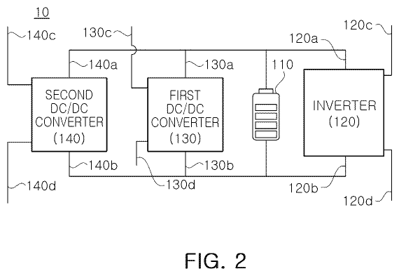

FIG. 2 illustrates a battery module according to an example embodiment of the present disclosure.

Referring to FIG. 2, a battery module 10 according to an example embodiment of the present disclosure may include a battery 110, an inverter 120, a first DC/DC converter 130, and a second DC/DC converter 140.

The battery 110 may output a battery voltage, and may charge or discharge electrical energy. In addition, the battery voltage may form a basic voltage of the battery module 10 to provide an input voltage to the inverter 120, the first DC/DC converter 130, and the second DC/DC converter 140.

In addition, the battery 110 may have a battery voltage having a magnitude, lower than that of the general high-voltage battery pack 11 described with reference to FIG. 1. Accordingly, a power conversion element, operable at a low voltage, may be applied to the vehicle battery module 10 according to an example embodiment of the present disclosure, thereby reducing production costs.

In addition, according to the battery module 10 according to an example embodiment of the present disclosure, various magnitudes and types of voltages may be output depending on a series or parallel combination of the battery modules 10, such that a single-standard battery module 10 may be applied to types of vehicles having various specifications, thereby reducing production costs.

For example, when the battery voltage is set to 100 V, four battery modules 10 may be connected to each other in series to form a battery module system outputting a voltage of 400 V, and eight battery modules 10 may be combined in series with each other to form a battery module system outputting a voltage of 800 V. In addition, for example, when the battery voltage is set to 50 V, eight battery modules 10 may be connected to each other in series to form a battery module system outputting a voltage of 400 V, and sixteen battery modules 10 may be connected to each other in series to form a battery module system outputting a voltage of 800 V.

In addition, the battery modules 10 may be connected to each other in series, a single-phase battery module system, outputting a high-voltage AC voltage, may be formed using an inverter output, and a three-phase AC voltage may be output using a plurality of single-phase battery module systems. In addition, the battery modules 10 may be combined in parallel with each other to form a battery module system through which a high current flows.

The inverter 120 may convert the battery voltage into an AC module voltage and output the AC module voltage. In addition, the inverter 120 may include input ends 120a and 120b and an output end 120c and 120d. The input ends 120a and 120b of the inverter may be connected to each other in parallel to a battery to receive a battery voltage, and output ends 120c and 120d of the inverter may output an AC module voltage. Hereinafter, the inverter output end 120c and 120d may be referred to as an AC module output end, outputting the AC module voltage. In addition, the inverter 120 may be configured to supply, to the AC load, AC power according to the AC module voltage. In this case, the AC load may be a load such as a motor using an AC voltage as a driving voltage.

In addition, the first DC/DC converter 130 may convert the battery voltage into a first DC module voltage lower than the battery voltage, and may output the first DC module voltage.

In addition, the first DC module voltage may be set to a driving voltage of a low-voltage load. For example, the low-voltage load may be an electric load such as various lamps radios, infotainment, or the like of an electric vehicle. In addition, the first DC module voltage may be set to 12V, 24V, or 48V, which is the driving voltage of the low-voltage load. However, a magnitude of voltage mentioned herein is only one example, and may be set to a voltage having various magnitudes depending on a design thereof.

In addition, the first DC/DC converter 130 may include input ends 130a and 130b and output ends 130c and 130d. The input ends 130a and 130b of the first DC/DC converter 130 may be connected to each other in parallel to the battery to receive a battery voltage, and the output ends 130c and 130d of the first DC/DC converter 130 may output the first DC module voltage. Hereinafter, the output ends 130c and 130d of the first DC/DC converter 130 may be referred to as first DC module output ends, outputting the first DC module voltage.

In addition, the output ends 130c and 130d of the first DC/DC converter 130 may be directly connected to the low-voltage load to provide the first DC module voltage.

In an example embodiment, one output end 130d among output ends of the first DC/DC converter 130 may be grounded, and the other output end 130c among output ends of the first DC/DC converter 130 may be connected to the low-voltage load to output the first DC module voltage. In another example embodiment, both output ends of the first DC/DC converter 130 may be connected to both ends of the low-voltage load to output the first DC module voltage.

In addition, the second DC/DC converter 140 may convert a battery voltage into a second DC module voltage and output the second DC module voltage. The second DC module voltage may be set to a value, greater than that of the first DC module voltage output from the first DC/DC converter 130. In addition, the second DC module voltage may be lower than or equal to the battery voltage, or may be higher than the battery voltage.

In addition, the second DC module voltage, output from the second DC/DC converter 140, may be connected in series to a second DC module voltage output from another battery module 10 to provide power to a high-voltage load. In other words, the second DC module voltage, output from the second DC/DC converter 140, may not provide power to the high-voltage load as a single output, but may be connected in series to the second DC module voltage of another battery module 10 to provide power to the high-voltage load. A battery voltage, included in the battery module 10, may be formed as a low voltage. In order to provide a voltage to a high-voltage load such as an air conditioning system or the like, a plurality of battery modules 10 may be combined in series with each other to provide a high voltage. In other words, the output ends of the second DC/DC converter may be connected in series to output ends of a second DC/DC converter of another battery module to form a high voltage, thereby providing power to the high-voltage load.

In addition, the second DC/DC converter may include input ends 140a and 140b and output ends 140c and 140d. The input ends 140a and 140b of the second DC/DC converter may be connected to each other in parallel to the battery 110 to receive a battery voltage, and the output ends 140c and 140d of the second DC/DC converter may output a second DC module voltage. As used herein, the output ends 140c and 140d of the second DC/DC converter may also be referred to as second DC module output ends, outputting the second DC module voltage.

In addition, the output ends 140c and 140d of the second DC/DC converter may be connected in series to output ends of a second DC/DC converter included in another battery module, or may be connected to a high-voltage load. In this case, a specific connection structure with another battery module 10 will be described below.

In addition, the battery 110 may be connected to each other in parallel to the input ends 120a and 120b of the inverter, the input ends 130a and 130b of the first DC/DC converter 130, and the input ends 140a and 140b of the second DC/DC converter.

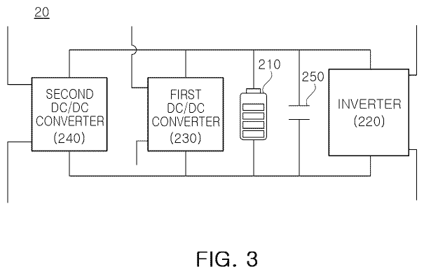

FIG. 3 illustrates a battery module according to an example embodiment of the present disclosure.

Referring to FIG. 3, a battery module 20 according to an example embodiment of the present disclosure may include a battery 210, an inverter 220, a first DC/DC converter 230, a second DC/DC converter 240, and a common capacitor 250. In addition, the common capacitor 250 may be connected to each other in parallel to the battery 210. The battery module 20, illustrated in FIG. 1, may include all components of the battery module 10 illustrated in FIG. 1, and may further include the common capacitor 250.

According to the battery module 20 according to an example embodiment of the present disclosure, one common capacitor may be shared without applying a capacitor for each inverter and each converter element. Accordingly, a volume thereof may be reduced, and a low-voltage capacitor may be applied, thereby reducing production costs.

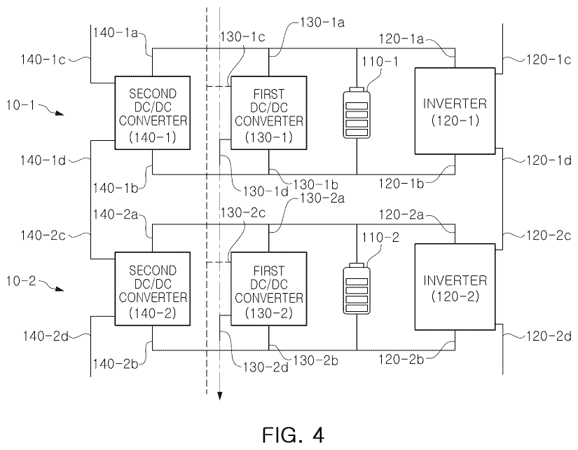

FIG. 4 is a diagram illustrating a connection structure between a plurality of battery modules according to an example embodiment of the present disclosure.

Referring to FIG. 4, a first battery module 10-1 and a second battery module 10-2 may include the same components, and may have the same structure. In addition, as described with reference to FIG. 2, the first battery module 10-1 and the second battery module 10-2 may include batteries 110-1 and 110-2, inverters 120-1 and 120-2, first DC/DC converters 130-1 and 130-2, and second DC/DC converters 140-1 and 140-2, respectively. Alternatively, as described with reference to FIG. 3, the first battery module 10-1 and the second battery module 10-2 may further include a common capacitor.

In addition, a plurality of battery modules may be connected to each other to form a battery module system, and a connection relationship between each of the plurality of battery modules, included in the battery module system, may be the same as the structure illustrated in FIG. 4.

More specifically, output ends 120-1d of the inverter 120-1, included in the first battery module 10-1, may be connected in series to output ends 120-2c of the inverter 120-2, included in the second battery module 10-2. In addition, when an inverter outputs an AC module voltage, the inverter 120-1, included in the first battery module, and the inverter 120-2, included in the second battery module, may be connected in series to output an AC module voltage having a magnitude twice as high as that of the AC module voltage. For example, when the AC module voltage is set to 100V, the two inverters 120-1 and 120-2, connected to each other in series, may output an AC voltage of 200V. In this case, a magnitude of the AC voltage may refer to a maximum value, an effective value, or an average value of the AC voltage.

In addition, output ends of the first DC/DC converter, included in the first battery module 10-1, may be connected to each other in parallel to output ends of the first DC/DC converter, included in the second battery module 10-2. In an example embodiment, one output end 130-1d of the first DC/DC converter included in the first battery module 10-1 may be grounded, and one output end 130-2d of the first DC/DC converter included in the second battery module 10-2 may be grounded. In addition, the other end 130-1c, among the output ends of the first DC/DC converter included in the first battery module 10-1, may be connected to each other in parallel to the other output end 130-2c, among the output ends of the first DC/DC converter included in the second battery module 10-2, to output a first DC module voltage. In addition, the output ends connected to each other in parallel to each other, among the output ends of the first DC/DC converters, may output a first DC module voltage, and may be connected to a low-voltage load using the first DC module voltage as a driving voltage to provide a voltage.

In addition, output ends of the second DC/DC converter, included in the first battery module 10-1, may be connected in series to output ends of the second DC/DC converter, included in the second battery module 10-2. More specifically, one output end 140-1d, among the output ends of the second DC/DC converter included in the first battery module 10-1, may be connected to the other output end 140-2c, among the output ends of the second DC/DC converter of the second battery module 10-2.

In addition, when a second DC/DC converter outputs a second DC module voltage, the second DC/DC converter 140-1, included in the first battery module 10-1, and a second DC/DC converter 140-2, included in the second battery module 10-2, may be connected to each other in series to output a second DC module voltage having a magnitude twice as high as that of the second DC module voltage. For example, when the second DC module voltage is set to 100 V, the two second DC/DC converters 140-1 and 140-2 may be connected to each other in series to output 200 V.

That is, the first battery module 10-1 and the second battery module 10-2 may be connected to each other in series, the first DC/DC converters may be connected to each other in parallel to each other, and the second DC/DC converters may be connected to each other in series.

Also, a single-phase battery module system 100 according to an example embodiment of the present disclosure may include a plurality of battery modules 10-1, 10-2, . . . , 10-N. In addition, each of the plurality of battery modules 10-1, 10-2, . . . , 10-N, included in the single-phase battery module system 100, may be the same as the battery modules 10 and 20 illustrated in FIG. 2 or 3. In addition, the plurality of battery modules 10-1, 10-2, . . . , 10-N, included in the single-phase battery module system 100, may have a connection structure between battery modules illustrated in FIG. 4.

Referring back to FIG. 2, the battery module according to an example embodiment of the present disclosure may include first DC module output ends 130c and 130d corresponding to output ends of a first DC/DC converter, second DC module output ends 140c and 140 corresponding to output ends of a second DC/DC converter, and AC module output ends 120c and 120d corresponding to output ends of an inverter.

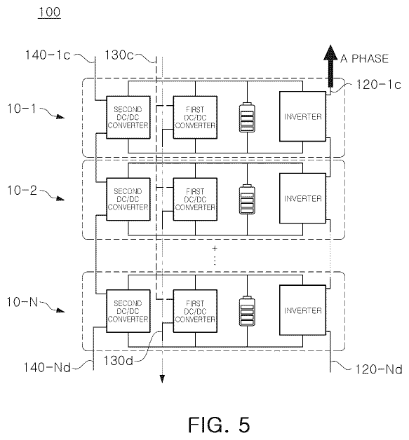

In addition, referring to FIG. 5, the single-phase battery module system 100 according to an example embodiment of the present disclosure may include first DC system output ends 130c and 130d in which first DC module output ends, respectively included in the plurality of battery modules, are connected to each other in parallel to each other. In this case, the first DC system output ends 130c and 130d may output a first DC system voltage, and the first DC system voltage may have a magnitude, the same as that of a first DC module voltage output from the output ends of the first DC/DC converter.

In addition, the single-phase battery module system 100 according to an example embodiment of the present disclosure may include second DC system output ends 140-1c and 140-Nd in which second DC module output ends, respectively included in the plurality of battery modules, are connected to each other in series. Here, the second DC system output ends 140-1c and 140-Nd may output a second DC system voltage, and the second DC system voltage may have a magnitude, integer (N) times as high as that of a second DC module voltage output from the output ends of the second DC/DC converter.

In addition, the single-phase battery module system 100 according to an example embodiment of the present disclosure may include AC system output ends 120-1c and 120-Nd in which AC module output ends, respectively included in the plurality of battery modules, are connected to each other in series. In addition, the AC system output ends 120-1c and 120-Nd may output an AC system voltage, and the AC system voltage may have a magnitude, integer (N) times as high as that of an AC module voltage output from the output ends of the inverter. The AC system output ends may provide AC power to an AC load, and may provide an input voltage for one phase of a three-phase AC voltage.

That is, in the single-phase battery module system 100, respective elements of the plurality of battery modules may be connected to each other in series or parallel to each other to provide various output voltages including a first DC system voltage, a second DC system voltage, and an AC system voltage.

In addition, an electric vehicle may include a low-voltage load R1 operating at a low voltage, a high-voltage load R2 operating at a high voltage, and an AC load, such as a motor M, operating at a high-voltage three-phase AC voltage. In addition, the low-voltage load may use a first DC system voltage as a driving voltage, the high-voltage load may use a second DC system voltage as a driving voltage, and the AC load may use an AC system voltage as a driving voltage.

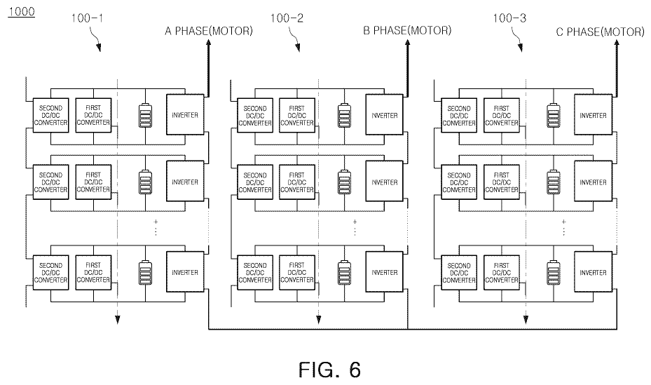

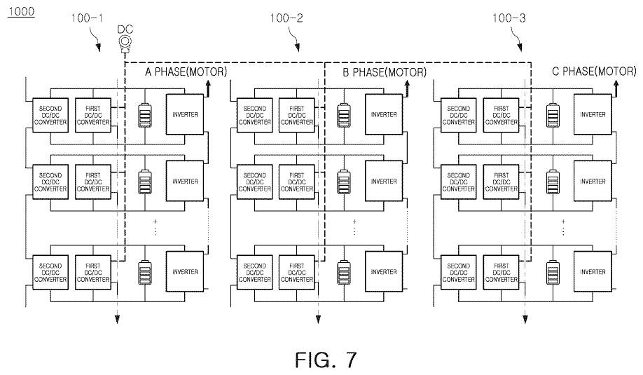

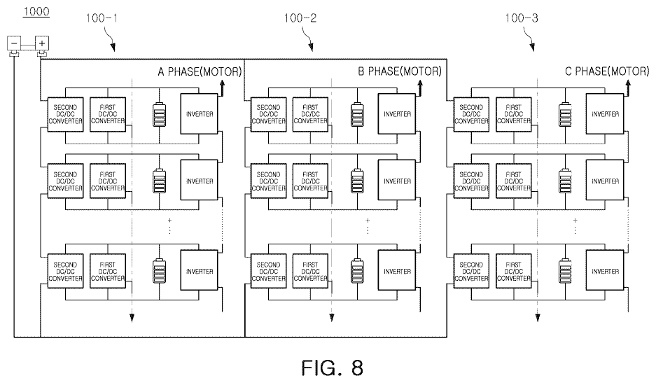

FIG. 6 is a diagram illustrating a connection relationship between inverters in a three-phase battery module system 1000 according to an example embodiment of the present disclosure. FIG. 7 is a diagram illustrating a connection relationship between first DC/DC converters in a three-phase battery module system according to an example embodiment of the present disclosure. FIG. 8 is a diagram illustrating a connection relationship between second DC/DC converters in a three-phase battery module system according to an example embodiment of the present disclosure.

Referring to FIGS. 6 to 8, the three-phase battery module system 1000 according to an example embodiment of the present disclosure may include a plurality of single-phase battery module systems 100-1, 100-2, and 100-3, and each of the single-phase battery module systems may include a plurality of battery modules.

Referring to FIG. 6, the three-phase battery module system 1000 according to an example embodiment of the present disclosure may include three single-phase battery module systems 100-1, 100-2, and 100-3. In addition, the single-phase battery module systems may include an AC system output end in which inverter output ends are connected to each other in series. In addition, the AC system output ends, respectively included in the three single-phase battery module system, may output different AC voltages having the same magnitude and the same phase difference.

For example, the AC system output ends, respectively included in the three single-phase battery module system, may output different AC voltages having a phase difference of 120 degrees. Accordingly, the three-phase battery module system may output a three-phase AC voltage, and may provide a driving voltage to a motor using the three-phase AC voltage as a driving voltage.

In addition, referring to FIG. 7, each of the plurality of single-phase battery module systems 100-1, 100-2, and 100-3, included in the three-phase battery module system 1000 according to an example embodiment of the present disclosure, may include a first DC system output end in which a plurality of first DC/DC converters are connected to each other in parallel to each other to output a first DC system voltage. In addition, the first DC system output ends, respectively included in the plurality of single-phase battery module systems 100, may be connected to each other in parallel to each other.

In other words, when the single-phase battery module system 100 includes N first DC/DC converters, 3*N first DC/DC converters, included in the three-phase battery module system 1000, may all be connected to each other in parallel to each other to output a first AC module voltage or a first DC system voltage having a magnitude, same as that of the first DC module voltage.

In addition, referring to FIG. 8, each of the plurality of single-phase battery module systems 100-1, 100-2, and 100-3, included in the three-phase battery module system 1000 according to an example embodiment of the present disclosure, may include a second DC system output end in which a plurality of second DC/DC converters connected to each other in series to output a second DC system voltage. In addition, the second DC system output ends, respectively included in the plurality of single-phase battery module systems 100-1, 100-2, and 100-3, may be connected to each other in parallel to each other. That is, in the single-phase battery module system 100, second DC module output ends may be connected to each other in series to form a second DC system output end. In the three-phase battery module system 1000, a plurality of second DC system output ends may be connected to each other in parallel to each other.

In FIGS. 4 to 8, the (−) terminals of the first DC/DC converters are illustrated as being connected to ground, or alternatively, the (−) terminals of the first DC/DC converters may be simply connected together.

In addition, the three-phase battery module system may further include a controller (not illustrated). The controller may individually control battery modules, and may individually control an inverter, a first DC/DC converter, and a second DC/DC converter included in each battery module. Accordingly, according to an example embodiment of the present disclosure, balancing control for each power conversion element and each battery module may be performed, thereby increasing energy efficiency.

In addition, when an issue occurs in a module among N number of battery modules, the controller may perform control to block only the battery module in which the issue has occurred, thereby ensuring reliability of the entire system.

In addition, the controller may individually control each battery module, such that, even when degradation occurs differently for each battery module, degradation performance of each battery module may be actively controlled.

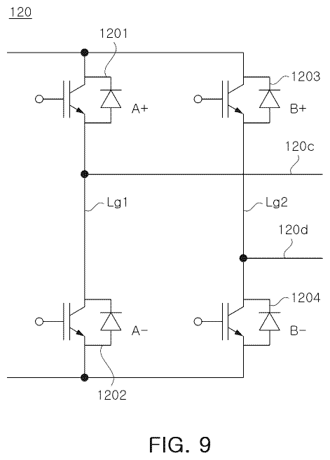

FIG. 9 is a diagram illustrating an inverter structure according to an example embodiment of the present disclosure.

The inverter 120 may include an upper switch 1201 and a lower switch 1202 provided in the first leg Lg1 and connected to each other in series, and an upper switch 1203 and a lower switch 120 provided in the second leg Lg2 and connected to each other in series. Here, among the output ends 120c and 120d of the inverter 112, one end 120c may be between the upper switch 1201 and the lower switch 1202 of the first leg Lg1, and the other end 120d among the output ends 112c and 112d of the inverter 112 may be between the upper switch 1203 and the lower switch 120 of the second leg Lg2.

Referring to FIG. 9, the inverter 120 may include a plurality of power semiconductor devices, such as, a plurality of Si-metal oxide semiconductor field effect transistor (MOSFET) elements 1201, 1202, 1203, and 1204, and may have an H-bridge single-phase inverter structure.

In an electric vehicle system according to the related art, a SiC power semiconductor may be mainly applied. The SiC power semiconductor may have high efficiency and rapid switching speed, but may be high-priced.

In addition, the general electric vehicle system may use an insulated gate bipolar transistor (IGBT) at a low voltage. The IGBT may be relatively low-priced, but may have slow switching speed.

The Si-MOSFET element may have rapid switching speed, and may be relatively low-priced. However, the Si-MOSFET element may have degraded performance at a high voltage such that it may be difficult to apply the Si-MOSFET element in the general high-voltage electric vehicle system.

The battery module according to an example embodiment of the present disclosure may be driven at a low voltage, a Si-MOSFET element may be applied to an inverter. Accordingly, the inverter, included in the battery module according to an example embodiment of the present disclosure, may use a plurality of Si-MOSFET elements such that production costs may be reduced and switching speed may increase. Accordingly, fuel efficiency may be improved such that a travel distance of a vehicle may increase, and as the travel distance increases, battery capacity may be reduced, thereby reducing production costs.

In addition, the inverter according to an example embodiment of the present disclosure may have an H-bridge single-phase inverter structure, and may maintain stability even under a high current.

In addition, FIG. 9 illustrates the example in which an H-bridge circuit is configured using four Si-MOSFETs. However, the H-bridge circuit may be formed by connecting a plurality of Si-MOSFETs in parallel to each other to enable switching of a high current.

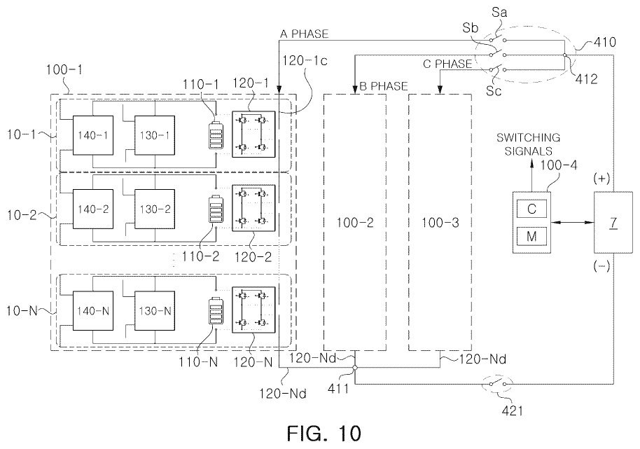

FIG. 10 is a configuration diagram illustrating a vehicle according to an example embodiment of the present disclosure.

As illustrated in FIG. 10, a vehicle according to an example embodiment of the present disclosure may include a plurality of single-phase battery module systems 100-1, 100-2, and 100-3, a control module 100-4, a plurality of switches Sa, Sb, and Sc for opening and closing connection between each of the plurality of single-phase battery module systems and the charger, a switch module 410 and a charger 7.

Here, the charger 7 may be a rapid charging facility installed externally of the vehicle and providing a DC type charging current, but an embodiment of the present disclosure is not limited thereto, and the charger 7 may include an on-board charger 3 converting AC power into DC charging current.

The plurality of single-phase battery module systems 100-1, 100-2, and 100-3 may include a plurality of battery modules.

For example, in the case of an A-phase of the motor, the single-phase battery module system 100-1 may include a plurality of battery modules 10-1, 10-2, and 10-N, and each of the plurality of battery modules 10-1, 10-2, and 10-N may include batteries 110-1, 110-2, and 110-N, inverters 120-1, 120-2, and 120-N, first DC/DC converters 130-1, 130-2, and 130-N, and second DC/DC converters 140-1, 140-2, and 140-N. Here, the input ends of the batteries 110-1, 110-2, and 110-N and the inverters 120-1, 120-2, and 120-N may be connected to each other in parallel, and the output ends of the inverters 120-1, 120-2, and 120-N may be connected in series to the output ends of the inverters included in the adjacent battery modules.

Although not illustrated separately for ease of description, the single-phase battery module systems 100-2 and 100-3 of the other phases (B phase and C phase) of the motor may also have the same configuration.

The number of the plurality of battery modules included in one single-phase battery module system among the plurality of single-phase battery module systems 100-1, 100-2, and 100-3 may be the same as the number of the plurality of battery modules included in another single-phase battery module system among the plurality of single-phase battery module systems.

In addition, the other end among output ends of the inverter included in one of the plurality of battery modules included in one of the single-phase battery module systems 100-1, 100-2, and 100-3 may be interconnected with the other end among output ends of the inverter included in one of the plurality of battery modules included in another other single-phase battery module system among the plurality of single-phase battery module systems 100-1, 100-2, and 100-3 and may be connected to the charger 2.

For example, among the plurality of battery modules 10-1, 10-2, and 10-N included in the single-phase battery module system 100-1, for example, the other end 120-Nd among output ends of the inverter 120-N included in the battery module 10-N disposed at a lowermost end may be interconnected with the other end 120-Nd among output ends of the inverter included in the battery module disposed at a lowermost end among the plurality of battery modules included in another single-phase battery module system 100-2, 100-3, for example, and may be connected to the (−) terminal of the charger 2.

That is, the single-phase battery module systems 100-1, 100-2, and 100-3 may be interconnected at the contact point 411, and a lower switch 421 may be further included between the contact point 411 and the charger 2.

The switch module 410 may include a plurality of switches Sa, Sb, and Sc, and the plurality of switches Sa, Sb, and Sc may open and close connection between each of the single-phase battery module systems 100-1, 100-2, and 100-N and the charger 2.

Specifically, one end of each of the plurality of switches Sa, Sb, and Sc may be connected to the (+) terminal of the charger 7 (see the interconnection 412), and the other ends of the plurality of switches Sa, Sb, and Sc may be connected to the plurality of single-phase battery module systems 100-1, 100-2, and 100-N.

That is, the other end of each of the plurality of switches Sa, Sb, and Sc may be connected to one of the plurality of battery modules included in each of the single-phase battery module systems 100-1, 100-2, and 100-3, for example, one end among output ends of the inverter included in the battery module disposed at the uppermost end.

For example, in the case of the A-phase of the motor, the other end of the switch (Sa) may be connected to one of the plurality of battery modules 10-1, 10-2, and 10-3 included in the single-phase battery module system 100-1, for example, one end 120-1c among output ends of the inverter 120-1 included in the battery module 10-1 disposed at the uppermost end, and may also be connected to the other single-phase battery module systems 100-2 and 100-3.

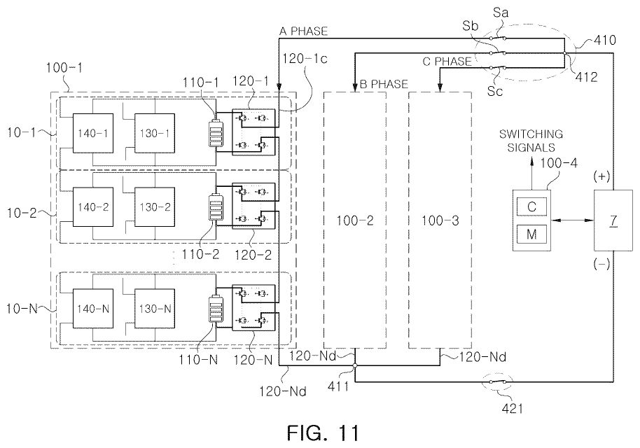

FIG. 11 is a diagram illustrating a charging path of a vehicle according to an example embodiment of the present disclosure. Hereinafter, a single-phase battery module system 100-1 will be described, but the description may be applied to the other single-phase battery module systems 100-2 and 100-3.

Specifically, according to an example embodiment of the present disclosure, as illustrated in FIGS. 9 to 11, the upper switch 1201 of the first leg Lg1 and the lower switch 1204 of the second leg Lg2 of each of the inverters 120-1, 120-2, and 120-N may be turned on, and the lower switch 1202 of the first leg Lg1 and the upper switch 1203 of the second leg Lg2 may be turned off. Conversely, the upper switch 1201 of the first leg Lg1 and the lower switch 1204 of the second leg Lg2 of the inverters 120-1, 120-2, and 120-N may be turned off, and the lower switch 1202 of the first leg Lg1 and the upper switch 1203 of the second leg Lg2 may be turned on.

Accordingly, the batteries 110-1, 110-2, and 110-N included in the battery module systems 100-1, 100-2, and 100-N may be charged through a path (see the bold solid line) as illustrated in FIG. 11. That is, the inverters 120-1, 120-2, and 120-N may operate to transfer the direct current voltage provided from the charger 2 to the battery through the motor windings La, Lb, and Lc.

Referring back to FIG. 10, the control module 100-4 may control the charging current provided from the charger 7 through switching signals for each of the battery module systems 100-1, 100-2, and 100-N. The control module 100-4 may include a controller C and a memory M.

The control module 100-4 may include a processor (e.g., a computer, a microprocessor, a CPU, an ASIC, a logic circuit, etc.) and a memory storing software instructions that provide various functions when executed by the processor. Here, the processor and the memory may be implemented as separate semiconductor circuits. Alternatively, the processor and the memory may be implemented as a single integrated semiconductor circuit. There may be more than one processor.

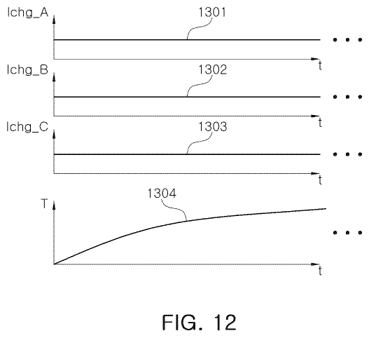

FIG. 12 is a diagram illustrating a charging current applied consecutively to each phase of a motor according to an example embodiment. In FIG. 12, reference numeral 1301 indicates the charging current Ichg_A of the A-phase of the motor, reference numeral 1302 indicates the charging current Ichg_B of the B-phase of the motor, reference numeral 1303 indicates the charging current Ichg_C of the C-phase of the motor, and reference numeral 1304 indicates the average temperature T of the battery modules included in the single-phase battery module systems 100-1, 100-2, and 100-3.

However, as illustrated in FIG. 12, when charging current is consecutively applied simultaneously to each phase of the motor, the average temperature 1304 of the battery modules may gradually increase, which may cause a decrease in the charging current and a decrease in the charging speed.

According to an embodiment of the present disclosure, the controller C may control the charging current of the plurality of single-phase battery module systems 100-1, 100-2, and 100-3, respectively, by performing pulse width modulation (PWM) control on the inverter included in the plurality of single-phase battery module systems 100-1, 100-2, and 100-3.

For example, the controller C may perform sequential pulse width modulation control for the inverters included in the plurality of single-phase battery module systems 100-1, 100-2, and 100-3, respectively.

Specifically, the controller C may control the charging current for the entirety of the plurality of single-phase battery module systems 100-1, 100-2, and 100-3 equally by performing pulse width modulation control according to the same duty ratio for the entirety of inverters included in the plurality of single-phase battery module systems 100-1, 100-2, and 100-3.

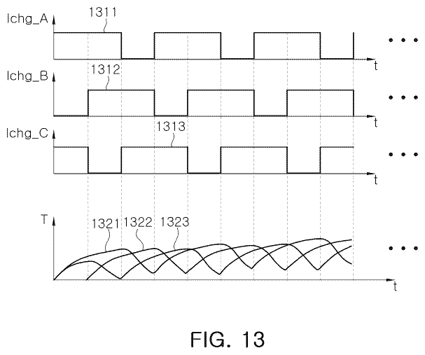

FIG. 13 is a diagram illustrating a charging current controlled equally for each phase of a motor through a pulse-width modulation method according to an example embodiment of the present disclosure. In FIG. 13, reference numeral 1311 indicates the charging current Ichg_A having the A-phase of the motor, reference numeral 1312 indicates the charging current Ichg_B having the B-phase of the motor, reference numeral 1313 indicates the charging current Ichg_C having the C-phase of the motor, reference numeral 1321 indicates the average temperature T of battery modules included in the single-phase battery module system 100-1 having the A-phase, reference numeral 1321 indicates the average temperature T of battery modules included in the single-phase battery module system 100-2 having the B-phase, and reference numeral 1321 indicates the average temperature T of battery modules included in the single-phase battery module system 100-3 having the C-phase.

As illustrated in FIG. 13, the controller C may control charging current equally for the entirety of the plurality of single-phase battery module systems 100-1, 100-2, and 100-3 by performing pulse width modulation control according to the same duty ratio.

Alternatively, the controller C may control charging current differently for the plurality of single-phase battery module systems 100-1, 100-2, and 100-3 by performing pulse width modulation control according to different duty ratios for the inverters included in the single-phase battery module systems 100-1, 100-2, and 100-3.

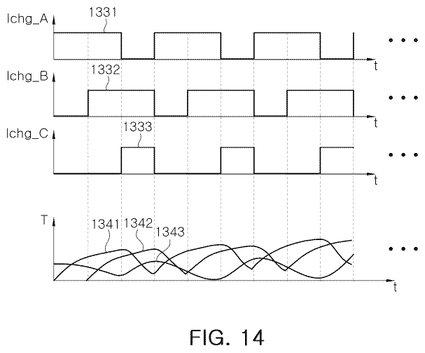

FIG. 14 is a diagram illustrating a charging current controlled differently for each phase of a motor through a pulse-width modulation method according to an example embodiment of the present disclosure. In FIG. 14, reference numeral 1331 indicates the charging current Ichg_A having the A-phase of the motor, reference numeral 1332 indicates the charging current Ichg_B having the B-phase of the motor, reference numeral 1333 indicates the charging current Ichg_C having the C-phase of the motor, reference numeral 1341 indicates the average temperature T of battery modules included in the single-phase battery module system 100-1 having the A-phase, reference numeral 1342 indicates the average temperature T of battery modules included in the single-phase battery module system 100-2 having the B-phase, and reference numeral 1343 indicates the average temperature T of battery modules included in the single-phase battery module system 100-3 having the C-phase.

FIG. 14 illustrates the example in which the A-phase and the B-phase of the motor are controlled by the same duty ratio, and the C-phase of the motor is controlled by the charging current with a duty ratio different from the A-phase. Since the charging current is controlled with a duty ratio smaller than those of the A-phase and B-phase of the motor, the average temperature T of the battery modules included in the single-phase battery module system 100-3 of the C-phase may be formed lower than the average temperature T of the battery modules included in the single-phase battery module systems 100-1 and 100-2 of the A-phase and the B-phase of the motor.

To control the temperature of the battery module, when at least one of the batteries included in the plurality of battery modules has a predetermined temperature or higher, the controller C may reduce the duty ratio for the inverter provided in the single-phase battery module system including the battery having a predetermined temperature or higher.

The memory M may store programs and data for implementing the above-described various functions of the control module 100-4.

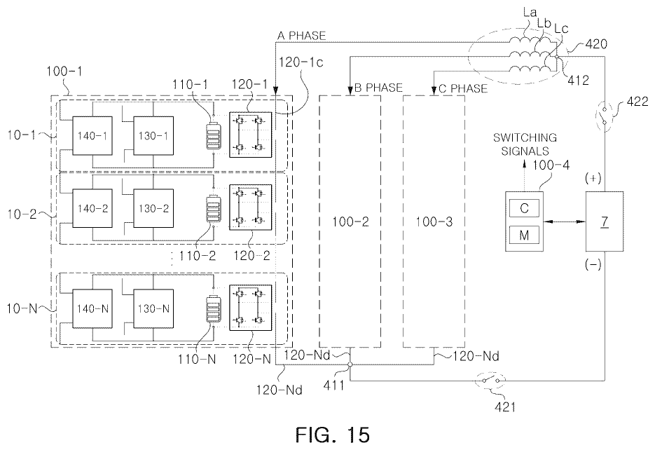

FIG. 15 is a configuration diagram illustrating a vehicle according to an example embodiment of the present disclosure.

As compared to FIG. 14, the configuration in which the switch module 410 may be replaced with a motor 420 including a plurality of motor windings La, Lb, and Lc and a switch 422 may be added may be different, and the other components and operations may be the same as the example in FIG. 14, such that the differences will be mainly described for ease of description.

Referring to FIG. 15, the motor 420 may include a plurality of motor windings La, Lb, and Lc, and the motor windings La, Lb, and Lc may be connected to the plurality of single-phase battery module systems 100-1, 100-2, and 100-3, respectively. The motor windings La, Lb, and Lc may operate as being short-circuited at DC. The motor windings La, Lb, and Lc may include, for example, a stator winding of the motor. As described above, by using a general stator winding instead of an inductor, it is not necessary to add an inductor, such that costs may be reduced, and it is not necessary to perform work such as neutral point connection, such that the time required for work may be reduced.

One end of each of the plurality of motor windings La, Lb, and Lc may be interconnected (see 412) and may be connected to the (+) terminal of charger 7, and the other ends of the plurality of motor windings La, Lb, and Lc may be connected to the plurality of single-phase battery module systems 100-1, 100-2, and 100-3, respectively.

Specifically, the other end of each of the plurality of motor windings La, Lb, and Lc may be connected to one of the plurality of battery modules included in each of the single-phase battery module systems 100-1, 100-2, and 100-3, for example, one end among output ends of the inverter included in the battery module disposed at the uppermost end.

For example, in the case of the A-phase of the motor, the other end of the motor winding La may be connected to one of the plurality of battery modules 10-1, 10-2, and 10-N included in the single-phase battery module system 100-1, for example, one end 120-1c among output ends of the inverter 120-1 included in the battery module 10-1 disposed at the uppermost end, and may also be connected to the other single-phase battery module systems 100-2 and 100-3.

Additionally, according to an embodiment of the present disclosure, an upper switch 422 may be further included between the motor winding module 420 and the charger 7.

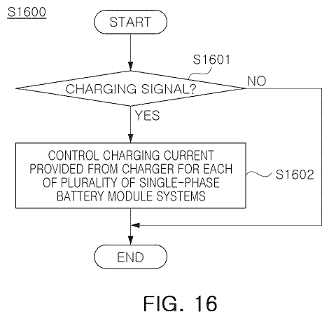

FIG. 16 is a flowchart illustrating a charging control method of a vehicle according to an example embodiment.

Referring to FIG. 16, a charging control method (S1600) of a vehicle according to an embodiment of the present disclosure may be initiated by an operation of receiving a charging signal from a charger 7 in a control module 100-4 (S1601).

Thereafter, when the charging signal is received, the control module 100-4 may control the charging current provided from the charger 7 by a plurality of single-phase battery module systems 100-1, 100-2, and 10-3 (S1602).

Here, as described above, a plurality of battery modules may be included, wherein each of the plurality of battery modules may include a battery and a power conversion module, and the power conversion module may include an inverter converting a DC voltage stored in the battery into an AC voltage and to control the motor, and the system may be provided for each phase of the motor.

Specifically, as described above, the control module 100-4 may control the charging current for each of the plurality of single-phase battery module systems by performing pulse width modulation (PWM) control for the inverters included in the single-phase battery module systems, respectively, for each of the plurality of single-phase battery module systems 100-1, 100-2, and 10-3.

Alternatively, as described above, the control module 100-4 may control the charging current for each of the plurality of single-phase battery module systems by performing pulse width modulation (PWM) control for the inverters included in the single-phase battery module system according to the same duty ratio for the plurality of single-phase battery module systems 100-1, 100-2, 10-3.

Alternatively, the control module 100-4 may control the charging current for each of the plurality of single-phase battery module systems by performing pulse width modulation (PWM) control for the inverter included in the single-phase battery module system according to different duty ratios for plurality of single-phase battery module systems 100-1, 100-2, and 10-3.

As described above, alternatively, the control module 100-4 may perform pulse width modulation control in sequence for the inverter included in the single-phase battery module system for each of the plurality of single-phase battery module systems.

Alternatively, as described above, when at least one of the batteries included in the plurality of battery modules system has a predetermined temperature or higher, the control module 100-4 may reduce the duty ratio for the inverter provided in the single-phase battery module system including the battery having a predetermined temperature or higher.

As described above, according to an embodiment of the present disclosure, by configuring the plurality of single-phase battery systems including the plurality of battery modules and controlling the charging current provided from the charger for each of the plurality of single-phase battery systems, a charging speed may be improved and also the temperature rise of the battery module may be suppressed.

In addition, according to an embodiment of the present disclosure, by configuring a system voltage of each single-phase battery system to be the same as a voltage for driving the motor, charging may be performed using a general charger.

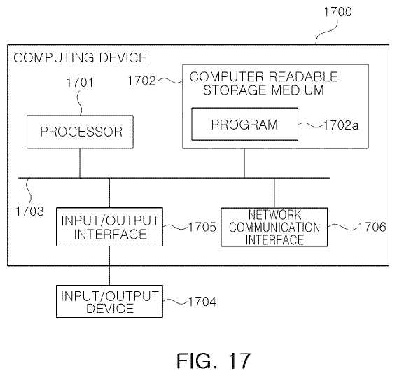

FIG. 17 is a block diagram illustrating a computing device which may fully or partially implement a control module 100-4 according to an example embodiment of the present disclosure.

As illustrated in FIG. 17, the computing device 1700 may include at least one processor 1701, a computer readable storage medium 1702, and a communication bus 1703.

The processor 1701 may cause the computing device 1700 to operate according to the embodiment described above. For example, the processor 1701 may execute one or more programs stored on the computer readable storage medium 1702. The one or more programs may include one or more computer-executable instructions, and when the computer-executable instructions are executed by the processor 1701, the computing device 1700 may perform operations according to the embodiment.

The computer readable storage medium 1702 may be configured to store computer-executable instructions to program code, program data, and/or other suitable forms of information. A program 1702a stored on the computer readable storage medium 1702 may include a set of instructions executable by the processor 1701. In an embodiment, the computer readable storage medium 1702 may be implemented as a memory (volatile memory, such as random access memory, nonvolatile memory, or a suitable combination thereof), one or more magnetic disk storage devices, optical disk storage devices, flash memory devices, or other types of storage medium accessed by the computing device 1700 and storing desired information, or a suitable combination thereof.

The communication bus 1703 may interconnect various other components of the computing device 1700, including the processor 1701, the computer readable storage medium 1702.

The computing device 1700 may also include one or more input/output interfaces 1705 and one or more network communication interfaces 1706 providing interfaces for one or more input/output devices 1704. The input/output interface 1705 and the network communication interface 1706 may be connected to the communication bus 1703. The network may be a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), or another cellular network.

The input/output device 1704 may be connected to other components of the computing device 1700 through the input/output interface 1705. The exemplary input/output devices 1704 may include input devices such as a pointing device (such as a mouse or trackpad), a keyboard, a touch input device (such as a touchpad or a touchscreen), a voice or sound input device, various types of sensor devices, and/or photographing devices, and/or output devices such as a display device, a printer, speakers, and/or a network card. The exemplary input/output device 1704 may be included in the computing device 1700 as a component included in the computing device 1700, or may be connected to the computing device 1700 as a device distinct from the computing device 1700.

The present disclosure may include a program for performing the methods described in this specification on a computer, and a computer-readable recording medium including the program. The computer-readable recording medium may include program commands, local data files, local data structures, or the like, alone or in combination. The medium may be designed and configured specifically for the present disclosure, or may be commonly available in the computer software field. Examples of the computer-readable recording medium may include magnetic media such as hard disks, floppy disks, and magnetic tapes, optical recording media such as CD-ROMs and DVDs, and hardware devices specifically configured to store and perform program commands such as ROMs, RAMs, and flash memories. Examples of the program may include machine language code produced by a compiler and also a high-level language code executed by a computer using an interpreter.

According to the aforementioned embodiments, by configuring the plurality of single-phase battery systems including a plurality of battery modules and controlling a charging current provided from the charger for each of the plurality of single-phase battery systems, the charging speed may be improved and the temperature rise of the battery module may be suppressed.

Also, by configuring a system voltage of each of the single-phase battery systems to be the same as the voltage for driving the motor, charging may be performed using a general charger.

While example embodiments have been illustrated and described above, it will be apparent to those skilled in the art that modifications and variations could be made without departing from the scope of the present disclosure as defined by the appended claims.

1. A vehicle, comprising:
a plurality of single-phase battery module systems including a plurality of battery modules, and provided in each phase of a motor, wherein each of the plurality of battery modules includes a battery and a power conversion module, and each power conversion module includes an inverter configured to convert a DC voltage stored in the battery into an AC voltage and to control the motor; and
a control module;
wherein the control module includes:
one or more processors; and
a storage medium configured to store computer-readable instructions; and
wherein, when a computer-readable instructions are executed by one or more processors, the one or more processors being configured such that a charging current provided from a charger is controlled by each of the plurality of single-phase battery module systems.

2. The vehicle of claim 1, wherein the one or more processors control the charging current for each of the plurality of single-phase battery module systems by performing pulse width modulation (PWM) control on an inverter included in the single-phase battery module system for each of the plurality of single-phase battery module systems.

3. The vehicle of claim 1, wherein the one or more processors control the charging current equally for each of the plurality of single-phase battery module systems by performing pulse width modulation (PWM) control for each of the inverters included in the single-phase battery module system of the plurality of single-phase battery module systems according to a same duty ratio.

4. The vehicle of claim 1, wherein the one or more processors control the charging current differently for the plurality of single-phase battery module systems by performing pulse width modulation (PWM) control for an inverter included in a single-phase battery module system according to different duty ratios for the plurality of single-phase battery module systems.

5. The vehicle of claim 1, wherein the one or more processors perform sequential pulse width modulation control for an inverter included in a single-phase battery module system for each of the plurality of single-phase battery module systems.

6. The vehicle of claim 1, wherein, when at least one of batteries included in the plurality of battery modules has a predetermined temperature or higher, the one or more processors reduces a duty ratio of an inverter provided in a single-phase battery module system including the battery having the predetermined temperature or higher.

7. The vehicle of claim 1, wherein the charger provides a DC charging current.

8. The vehicle of claim 1,
wherein input ends of the battery and the inverter are connected to each other in parallel, and
wherein an output end of the inverter is connected in series to an output end of an inverter included in an adjacent battery module.

9. The vehicle of claim 1, further comprising:
a plurality of switches configured to open and close connections between each of the plurality of single-phase battery module systems and a charger.

10. The vehicle of claim 9,
wherein one end of each of the plurality of switches is interconnected and connected to a (+) terminal of the charger, and
wherein an other end of each of the plurality of switches is connected to each of the plurality of single-phase battery module systems.

11. The vehicle of claim 10, wherein the other end of each of the plurality of switches is connected to one end among output ends of an inverter included in one of the plurality of battery modules included in each of the plurality of single-phase battery module systems.

12. The vehicle of claim 10, further comprising
a motor including a plurality of motor windings.

13. The vehicle of claim 12,
wherein one end of each of the plurality of motor windings is interconnected and connected to the (+) terminal of the charger, and
wherein an other end of each of the plurality of motor windings is connected to each of the plurality of single-phase battery module systems.

14. The vehicle of claim 13, wherein the other end of each of the plurality of motor windings is connected to one end among output ends of an inverter included in one of the plurality of battery modules included in each of the plurality of single-phase battery module systems.

15. A charging method of a vehicle including a plurality of single-phase battery module systems including a plurality of battery modules, and provided in each phase of a motor, wherein each of the plurality of battery modules includes a battery and a power conversion module, and each power conversion module includes an inverter configured to convert a DC voltage stored in the battery into an AC voltage and to control the motor, the charging method comprising:
a receiving operation of receiving a charging signal from a charger; and
a control operation of controlling a charging current provided from the charger for each of the plurality of single-phase battery module systems when the charging signal is received.

16. The charging control method of claim 15, wherein the control operation includes controlling the charging current for each of the plurality of single-phase battery module systems by performing pulse width modulation (PWM) control on an inverter included in the single-phase battery module system for each of the plurality of single-phase battery module systems.

17. The charging control method of claim 15, wherein the control operation includes controlling the charging current equally for each of the plurality of single-phase battery module systems by performing pulse width modulation (PWM) control for each of inverters included in a single-phase battery module system of the plurality of single-phase battery module systems according to the same duty ratio.

18. The charging control method of claim 15, wherein the control operation includes controlling the charging current differently for each of the plurality of single-phase battery module systems by performing pulse width modulation (PWM) control for an inverter included in a single-phase battery module system according to different duty ratios for the plurality of single-phase battery module systems.

19. The charging control method of claim 15, wherein the control operation includes performing pulse width modulation control in sequence for an inverter included in a single-phase battery module system for each of the plurality of single-phase battery module systems.

20. The charging control method of claim 15, wherein the control operation includes reducing, when at least one of batteries included in the plurality of battery modules has a predetermined temperature or higher, a duty ratio of an inverter provided in a single-phase battery module system including the battery having the predetermined temperature or higher.
